(19) United States
(12) Patent Application Publication
(10) Pub. No.: US 2013/0028365 A1
(43) Pub. Date: Jan. 31, 2013

(54) POWER GENERATION FROM DECAY HEAT FOR SPENT NUCLEAR FUEL POOL COOLING AND MONITORING

(71) Applicants: EMRE TATLI, Monroeville, PA (US); Joseph G. Belechak, Cranberry Township, PA (US); Baofu Lu, Seven Fields, PA (US); Cory A. Stansbury, Zelienople, PA (US); Cenk Guler, Irwin, PA (US); Michael Joseph Ostrosky, New Kensington, PA (US)

(72) Inventors: EMRE TATLI, Monroeville, PA (US); Joseph G. Belechak, Cranberry Township, PA (US); Baofu Lu, Seven Fields, PA (US); Cory A. Stansbury, Zelienople, PA (US); Cenk Guler, Irwin, PA (US); Michael Joseph Ostrosky, New Kensington, PA (US)

(73) Assignee: WESTINGHOUSE ELECTRIC COMPANY LLC, CRANBERRY TOWNSHIP, PA (US)

(21) Appl. No.: 13/558,443

(22) Filed: Jul. 26, 2012

Related U.S. Application Data
(60) Provisional application No. 61/513,051, filed on Jul. 29, 2011.

(51) Int. Cl. G21C 19/00

(52) U.S. Cl. 376/272

(57) ABSTRACT

An auxiliary power source for continuously powering pumps for replenishing water in a spent fuel pool and sensors monitoring the pool, in the event of a station blackout at a nuclear plant. The power source uses waste heat from spent fuel within the pool to activate a thermoelectric module system or a waste heat engine, such as a Stirling cycle or organic Rankine cycle engine to generate power for the pump and sensors. The auxiliary power source can also power a cooling system to cool the spent fuel pool.

### CROSS REFERENCE TO RELATED APPLICATION

This application claims priority from Provisional Application Ser. No. 61/513,051, filed Jul. 29, 2011.

### BACKGROUND

1. Field

This invention relates in general to spent nuclear fuel pools and, more particularly, to power sources which can back up spent nuclear fuel pool cooling and monitoring in the event of a power outage.

2. Related Art

Pressurized water nuclear reactors are typically refueled on an eighteen month cycle. During the refueling process, a portion of the irradiated fuel assemblies within the core are removed and replaced with fresh fuel assemblies which are relocated around the core. The removed spent fuel assemblies are typically transferred under water to a separate building that houses a spent fuel pool in which these radioactive fuel assemblies are stored. The water in the spent fuel pools is deep enough to shield the radiation to an acceptable level and prevents the fuel rods within the fuel assemblies from reaching temperatures that could breach the cladding of the fuel rods which hermetically house the radioactive fuel material and fission products. Cooling continues at least until the decay heat within the fuel assemblies is brought down to a level where the temperature of the assemblies is acceptable for dry storage.

Events in Japan's Fukushima Daiichi nuclear power plant reinforced concerns of the possible consequences of a loss of power over an extended period to the systems that cool spent fuel pools. As the result of a tsunami there was a loss of off-site power which resulted in a station blackout period. The loss of power shut down the spent fuel pool cooling systems. The water in some of the spent fuel pools dissipated through vaporization and evaporation due to a rise in the temperature of the pools, heated by the highly radioactive spent fuel assemblies submerged therein. Without power over an extended period to pump replacement water into the pools the fuel assemblies could potentially become uncovered, which could, theoretically, raise the temperature of the fuel rods in those assemblies, possibly leading to a breach in the cladding of those fuel rods and the possible escape of radioactivity into the environment.

It is an object of this invention to provide a back-up system that is capable of sustaining spent fuel pool cooling, independent of on- or off-site power, utilizing the power derived from the waste decay heat generated in the spent fuel pool.

### SUMMARY OF THE INVENTION

These and other objects are achieved by a spent fuel storage facility design having a spent fuel building enclosing a spent fuel pool filled with a radiation shielding liquid. A spent fuel rack within the spent fuel pool is provided for supporting spent fuel or other irradiated reactor components. A power generation system is provided that is responsive to a temperature difference between either the spent fuel rack and the radiation shielding liquid, or the radiation shielding liquid and the ambient environment to supply power without input from off-site sources. A pump system is powered by the power generation system to add a suitable liquid coolant into the spent fuel pool. The pump is configured with a fluid intake from an auxiliary reservoir of the liquid coolant and a fluid outlet that discharges into the spent fuel pool. The pump system is operable to turn on the pump when the radiation shielding liquid in the spent fuel pool gets below a certain level. Desirably, the radiation shielding liquid and the liquid coolant both comprise water.

Preferably, the spent fuel storage facility includes sensors within the spent fuel building that monitor a condition of the spent fuel pool. Desirably, the sensors can be powered by the power generation system and transmit the condition of the spent fuel pool to a remote location when other power sources are not available.

In one embodiment, the power generation system comprises a thermoelectric module. Preferably, the thermoelectric module is supported within the spent fuel pool by the spent fuel racks. In a second embodiment, the power generation system comprises a Stirling engine. In a third embodiment, the power generation system comprises an organic Rankine cycle engine. In another embodiment, the power generation system comprises redundant power generators and, preferably, each of the power generators relies on a different principle for converting the temperature difference to generate power.

### BRIEF DESCRIPTION OF THE DRAWINGS

A further understanding of the invention can be gained from the following description of the preferred embodiments when read in conjunction with the accompanying drawings in which:

FIG. 1 is a schematic of a spent fuel pool facility constructed in accordance with the embodiments of this invention described hereafter;

FIG. 2 is a schematic of a thermoelectric module that can be used as part of the power generation system employed in the embodiment of FIG. 1;

FIG. 3 is a schematic of an alpha-type Stirling engine which can be employed in the power generation system of the embodiments shown in FIG. 1;

FIG. 4 is a schematic of a beta-type Stirling engine which can be employed in the power generation system of the embodiments illustrated in FIG. 1; and

FIG. 5 is a schematic of an organic Rankine cycle engine which can be employed in the power generation system of the embodiments illustrated in FIG. 1.

### DESCRIPTION OF THE PREFERRED EMBODIMENT

The concerns over the potential consequences of a station blackout resulting in a loss of cooling of the spent fuel pool over an extended period became reinforced after a tsunami disabled Japan's Fukushima Daiichi nuclear power plant. This invention presents a means of providing additional pathways for continued cooling of the spent fuel pool contents in nuclear power plants when there is no external power available.

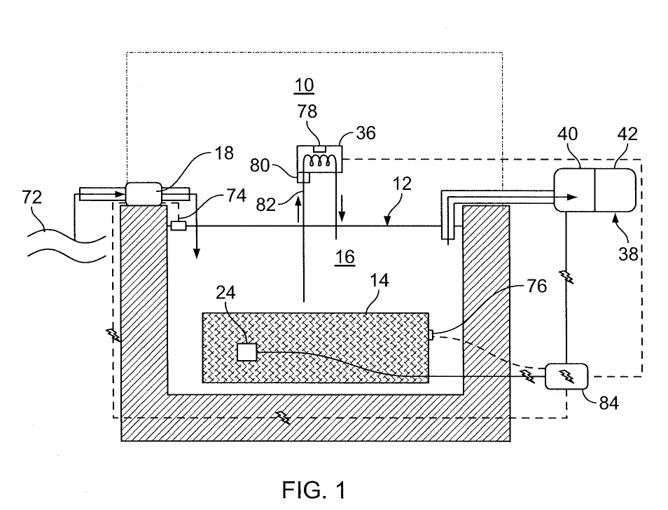

FIG. 1 shows a spent fuel pool 12 enclosed within a spent fuel pool building 10. A fuel rack 14 is situated within the spent fuel pool 12 and is submerged in a pool of borated water 16. The fuel rack 14 supports a number of radioactive spent fuel assemblies after having been removed from an adjacent reactor system (not shown). Typically, a recirculation system recirculates the borated water in the spent fuel pool 12 through a heat exchange system, where it is cooled to maintain the temperature of the spent fuel pool at a desired level and assure that the cladding of the fuel rods within the fuel assemblies remains below a temperature which could result in cladding failure. When there is no power for the cooling pumps to operate during a station blackout, the decay heat from the fuel rods causes the pool water temperature to rise, and eventually the water level in the pool will start to decrease due to evaporation. Replacing this lost water may keep the fuel from overheating and/or becoming uncovered, but power is required to run auxiliary pump 18 which is connected to a make-up reservoir for adding water to the spent fuel pool. Desirably, the intake pump 18 is connected to an ocean, sea, lake or other sizable water source for this purpose. In accordance with the embodiments described herein, the decay heat from the spent fuel in the pool 12 is used to generate the needed power. The power can also be employed to operate a cooler 36, such as a fan 78 which can be oriented to pass air, preferably drawn from outside the spent fuel pool building 10, over the borated water from the pool 12, circulated through the conduit 82 by a pump 80, to cool the borated water in the spent fuel pool. Both the fan 78 and the pump 80 draw their power through the power distribution block 84.

There are two general approaches described herein for the case wherein the power to be generated is electricity. Each approach can be used independently, but employing them in parallel can yield a more efficient and reliable system.

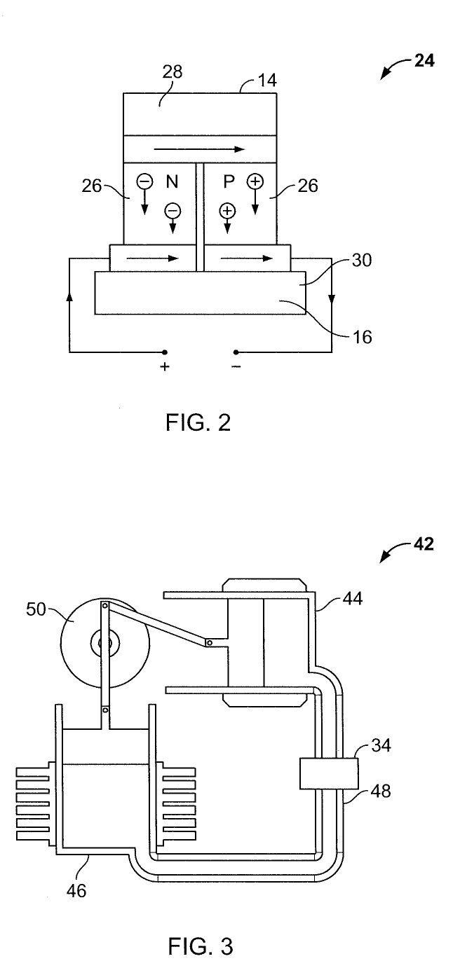

The first general approach is to use commercially available thermoelectric modules 24 to transform the decay heat into electricity, using the temperature difference between the borated water in the spent fuel pool 16 and the fuel rack 14. The thermoelectric modules 24 can be installed on the fuel racks 14 as shown in FIG. 1. Thermoelectric modules are commercially available and one is schematically illustrated in FIG. 2 and shown attached to a fuel rack 14 and identified by reference character 24 in FIG. 1. A thermoelectric module 24 generally consists of two or more elements of N and P-type doped semiconductor material 26 that are connected electrically in series and thermally in parallel. N-type material is doped so that it will have an excess of electrons (more electrons than needed to complete a perfect molecular lattice structure) and P-type material is doped so that it will have a deficiency of electrons (fewer electrons than are necessary to complete a perfect lattice structure). The extra electrons in the N material and the “holes” resulting from the deficiency of electrons in the P material are the carriers which move the heat energy from a heat source 28 through the thermoelectric material to a heat sink 30. The electricity that is generated by a thermoelectric module is proportional to the magnitude of the temperature difference between each side of the module.

The second option is to use a waste heat engine 38 to generate electricity for the pumps. Such an engine 38 may use, for example, a Stirling cycle or an organic Rankine cycle.

A Stirling engine is a heat engine operating by cyclic compression and expansion of air or other gases, commonly referred to as the working fluid, at different temperature levels such that there is a net conversion of heat energy to mechanical work; in this case, to drive an electric generator. An alpha-type Stirling engine 42 is illustrated in FIG. 3 and includes two cylinders 44 and 46. The expansion cylinder 44 is maintained at a high temperature, e.g., in contact with the borated water from the spent fuel pool, while the compression cylinder 46 is cooled, e.g., with ambient air. The passage 48 between the two cylinders contains a regenerator 34. The regenerator is an internal heat exchanger and temporary heat store placed between the hot and cold spaces such that the working fluid passes through it first in one direction then the other. Its function is to retain, within the system, that heat which will otherwise be exchanged with the environment at temperatures intermediate to the maximum and minimum cycle temperatures, thus enabling the thermal efficiency of the cycle to approach the limiting Carnot efficiency defined by those maxima and minima temperature extremes.

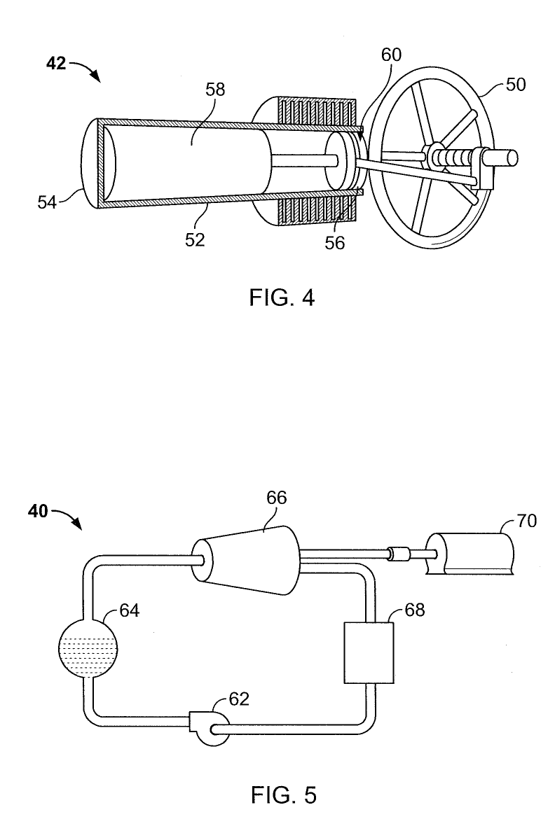

FIG. 4 illustrates a beta-type Stirling engine. There is only one cylinder 52 in a beta-type Stirling engine. The cylinder 52 is maintained hot at one end 54 and cold at the other 56. A loose fitting displacer 58 shunts the air between the hot and cold ends of the cylinder. A power piston 60 at the end of the cylinder drives the fly wheel 50.

Another waste heat engine that can be used for driving the electric generator 70 is an organic Rankine cycle engine schematically illustrated in FIG. 5 by reference character 40. The Rankine cycle is the heat engine operating cycle used by all steam engines. As with most engine cycles, the Rankine cycle is a four-stage process schematically shown in FIG. 5. The working fluid is pumped by a pump 62 into a boiler 64. While the fluid is in the boiler, an external heat source heats the fluid. The hot water vapor then expands to drive a turbine 66. Once passed the turbine, the steam is condensed back into liquid and recycled back to the pump to start the cycle all over again. The pump 62, boiler 64, turbine 66 and condenser 68 are the four parts of a standard steam engine and represent each phase of the Rankine cycle. The organic Rankine cycle operates with the same principle as a traditional steam Rankine cycle, as utilized by the great majority of thermal power plants today. The primary difference is the use of an organic chemical as the working fluid rather than steam. The organic chemicals used by an organic Rankine cycle include freon and most other traditional refrigerants such as iso-pentane, CFCs, HFCs, butane, propane and ammonia. These gases boil at extremely low temperatures allowing their use for power generation at low temperatures. There are a few other differences as well. Heating and expansion occur with the application of heat to an evaporator, not a boiler. The condenser can utilize ambient air temperatures to cool the fluid back into a liquid. There is no need for direct contact between the heat source at the evaporator or the cooling source at the condenser. A regenerator may also be used to increase the efficiency of the system.

Both the Rankine cycle engine and the Stirling cycle engine will use the heated bulk spent fuel pool water for their heat input and ambient air for their cool side. The thermoelectric module approach and the waste heat engine approach can be used together since neither method effects the other's operation. Also, there is a favorable negative feedback loop, that is, as the fuel and pool water heats up, the efficiency of these systems increase.

Referring back to FIG. 1, it can be appreciated that the system can be initiated as the level of the borated water 16 within the pool 12 depletes, by the float 74 which enables the pump 18 to draw water from the reservoir 72 into the pool. Additionally, sensors 76 can be powered by either the auxiliary power source 24 or 38 to provide signals to remote locations indicative of the condition of the spent fuel pool and its contents so that the condition of the plant can be managed accordingly.

While specific embodiments of the invention have been described in detail, it will be appreciated by those skilled in the art that various modifications and alternatives to those details could be developed in light of the overall teachings of the disclosure. For example, the Stirling engine or the Rankine cycle engine can be directly connected to the pumps to mechanically drive the pumps rather than generate electricity for that purpose. Accordingly, the particular embodiments disclosed are meant to be illustrative only and not limiting as to the scope of the invention which is to be given the full breadth of the appended claims and any and all equivalents thereof.

What is claimed is:

1. A spent fuel storage facility comprising:
a. a spent fuel building;
b. a spent fuel pool filled with a radiation shielding liquid, housed within the spent fuel building;
c. a spent fuel rack within the spent fuel pool for supporting spent fuel or other irradiated reactor components;
d. a power generation system responsive to a temperature difference between either the spent fuel rack and the radiation shielding liquid, or the radiation shielding liquid and the ambient environment to generate power without input from off-site sources; and
e. a pump system having an input connected to an output of the power generation system for powering the pump, a fluid intake from an auxiliary reservoir of a liquid coolant and a fluid outlet that discharges into the spent fuel pool.

2. The spent fuel storage facility of claim 1 including sensors within the spent fuel building that monitor a condition of the spent fuel pool, the sensors are connected to and are at least in part powered by the output of the power generation system and transmit the condition of the spent fuel pool to a remote location.

3. The spent fuel storage facility of claim 1 wherein the power generation system comprises a thermoelectric module.

4. The spent fuel storage facility of claim 3 wherein the thermoelectric module is supported within the spent fuel pool by the spent fuel racks.

5. The spent fuel storage facility of claim 1 wherein the power generation system comprises a Stirling Engine.

6. The spent fuel storage facility of claim 1 wherein the power generation system comprises an organic Rankine Cycle Engine.

7. The spent fuel storage facility of claim 1 wherein the power generation system comprises redundant power generators and each of the power generators relies on a different principal for converting the temperature difference to generate power.

8. The spent fuel storage facility of claim 1 wherein the power generation systems operate a cooler which is configured to cool the radiation shielding liquid in the spent fuel pool.

9. The spent fuel storage facility of claim 8 wherein the cooler includes a heat exchanger through which the radiation shielding liquid is circulated and a fan for flowing air over a conduit through which the radiation shielding liquid is circulated.
